(19) United States
(12) Patent Application Publication
(10) Pub. No.: US 2012/0054823 A1
(43) Pub. Date: Mar. 1, 2012

(54) AUTOMATED CONTROL METHOD AND APPARATUS OF DDOS ATTACK PREVENTION POLICY USING THE STATUS OF CPU AND MEMORY

(75) Inventor: Dae Won KIM, Daejeon (KR)

(73) Assignee: ELECTRONICS AND TELECOMMUNICATIONS RESEARCH INSTITUTE, Daejeon (KR)

(21) Appl. No.: 13/216,486

(22) Filed: Aug. 24, 2011

(30) Foreign Application Priority Data
Aug. 24, 2010 (KR) 10-2010-0082074

(51) Int. Cl. G06F 21/00; G06F 17/00; G06F 11/00

(52) U.S. Cl. 726/1

(57) ABSTRACT

Disclosed are a control technique of DDoS attack prevention policy at a host level, and more specifically, to an automated control method and an apparatus of DDoS attack prevention policy using the status of CPU and memory. An exemplary embodiment of the present invention provides an automated control method and an apparatus of DDoS attack prevention policy that monitors the usage rate of a CPU and a memory of a server and if a service failure is detected, controls the DDoS attack prevention policy according to the degree of abnormal status to stably provide the service by stabilizing the usage rate of the CPU and the memory.

### CROSS-REFERENCE TO RELATED APPLICATIONS

This application claims priority under 35 U.S.C. §119 to Korean Patent Application No. 10-2010-0082074, filed on Aug. 24, 2010, in the Korean Intellectual Property Office, the disclosure of which is incorporated herein by reference in its entirety.

### TECHNICAL FIELD

The present invention relates to a control technique of DDoS attack prevention policy at a host level, and more particularly, to an automated control method and an apparatus of DDoS attack prevention policy using the status of a CPU and a memory.

### BACKGROUND

Lots of systems have been developed in order to prevent DDoS (Distributed Denial of Service) attack at a host level, and these systems are generally comprised of an attack detecting function and an attack preventing function.

The DDoS attack is blocked by the attack preventing function, in the end and the corresponding prevention policy has a either fixed threshold or a threshold reflecting the result of the attack preventing function.

However, the known systems apply the attack prevention policy based on traffic flowing therein regardless of the status (for example, usage rate of a CPU or a memory) of a host (hereinafter, referred to as server) that provides services. Therefore, if a loose policy is applied, the possibility of service problems caused by the attack may be increased. In contrast, if a strict policy is applied, even though the service can be normally provided, the possibility that service requests from normal users are blocked may be increased.

Since the pattern of the known attack prevention policy has already analyzed by the attackers who develop the DDoS attack program, simply determining the prevention policy based on the inflow traffic is vulnerable to new DDoS attack pattern that has not been known.

### SUMMARY

An exemplary embodiment of the present invention provides an automated control method of DDoS attack prevention policy of a DDoS attack defense system, including: determining a status of a server by monitoring a usage rate of a CPU and a memory of the server that provides services; and controlling the DDoS attack prevention policy according to the determined status of the server.

Another exemplary embodiment of the present invention provides an automated control method of DDoS attack prevention policy, including: collecting information regarding a usage rate of a CPU and a memory of a service server; determining if the server is abnormal by analyzing the collected information; and if it is determined that the server is abnormal, generating a DDoS attack prevention policy to apply the policy.

Yet another exemplary embodiment of the present invention provides an automated control apparatus of DDoS attack prevention policy included in a DDoS attack defense system, including: a determining unit configured to determine a status of a server by monitoring a usage rate of a CPU and a memory of the server that provides services; and a controlling unit configured to control the DDoS attack prevention policy according to the determined status of the server.

Still another exemplary embodiment of the present invention provides an automated control apparatus of a DDoS attack prevention policy, including: a collecting unit configured to collect information regarding a usage rate of a CPU and a memory of a service server; a determining unit configured to determine if the server is abnormal by analyzing the collected information; and an applying unit configured to generate a DDoS attack prevention policy to apply if it is determined that the server is abnormal.

Other features and aspects will be apparent from the following detailed description, the drawings, and the claims.

### BRIEF DESCRIPTION OF THE DRAWINGS

FIG. 1 is a conceptual diagram illustrating an automated control method of a DDoS attack prevention policy according to an exemplary embodiment of the present invention.

FIG. 2 is a block diagram illustrating a conceptual position of the present invention in a DDoS defense system.

FIG. 3 is a flow chart illustrating an automated control method of a DDoS attack prevention policy according to an exemplary embodiment of the present invention.

FIG. 4 is a flow chart more specifically illustrating step S100.

FIG. 5 is a flow chart more specifically illustrating step S200.

FIG. 6 is a diagram illustrating step S210.

FIG. 7 is a diagram illustrating step S220.

FIG. 8 is a flow chart specifically illustrating step S300.

FIG. 9 is a diagram illustrating step S320.

FIG. 10 is a diagram illustrating an operation at an emergency level at step S320.

FIG. 11 is a diagram illustrating an operation at a warning level at step S320.

FIG. 12 is a block diagram illustrating an automated control apparatus of a DDoS attack prevention policy according to an exemplary embodiment of the present invention.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

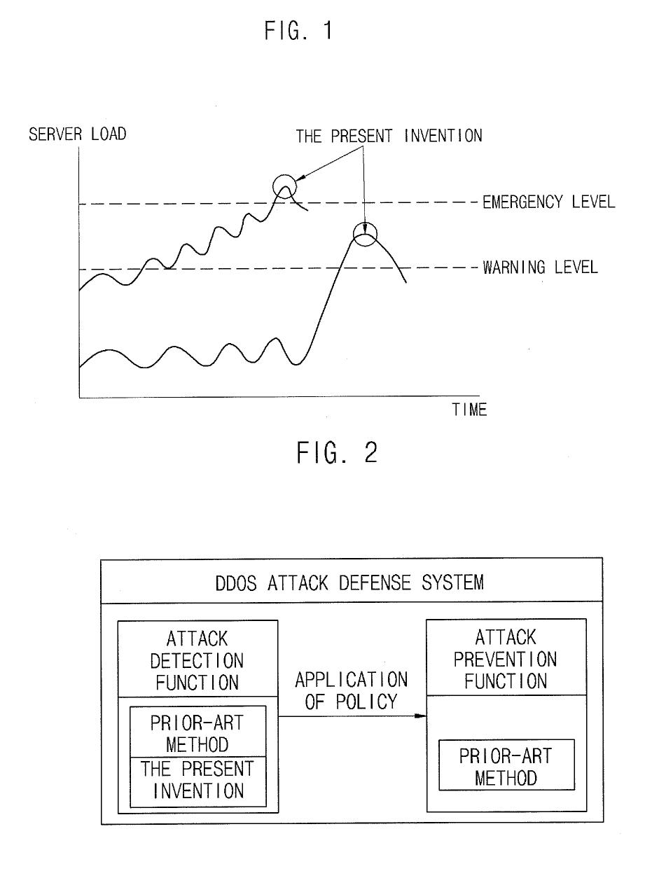

Hereinafter, with reference to FIGS. 1 and 2, the concept of an automated control method of a DDoS attack prevention policy according to an exemplary embodiment of the invention will be briefly described. FIG. 1 is a conceptual diagram illustrating an automated control method of DDoS attack prevention policy according to an exemplary embodiment of the present invention and FIG. 2 is a block diagram illustrating a conceptual position of the present invention in a DDoS defense system.

Referring to FIG. 1, the object of the present invention corresponding to a server load (usage rate of a CPU and a memory) will be described. According to the related art, even when the DDoS defense system is operated, the server load such as the usage rate of the CPU and the memory is increased. However, according to the exemplary embodiment, the server load is directly monitored. Therefore, if the server is detected as an abnormal status, prevention policy is generated and applied so that the server is recovered to a normal status.

In the exemplary embodiment, the basic principle of detection is to analyze the average difference between the variation of current usage rate and the variation of the past usage rate of the server based on the average difference between the current usage rate and the past usage rate of the server. For example, when the current usage rate exceeds the reference usage rate, if the current usage rate is higher than the past usage rate by a predetermined value, and the variation of the current usage rate is higher than the variation of the past usage rate by a predetermined value, it is determined that the server is abnormal.

The basic principle of generating a prevention policy is to control the set value of the current prevention policy based on the difference between the average past usage rate and the current usage rate analyzed in the detection part and the difference between the average variation and the current usage rate. For example, as the difference between the current usage rate and the average value becomes larger, or the difference between the current usage rate and the average variation becomes larger, the set value of the prevention policy can be enforced.

As shown in FIG. 2, according to the exemplary embodiment of the invention, the attack detection function is included in the DDoS defense system, and the attack detection function changes the policies of the attack prevention function to block/relieve the DDoS attack, similarly to the known conventional methods having an attack detection function.

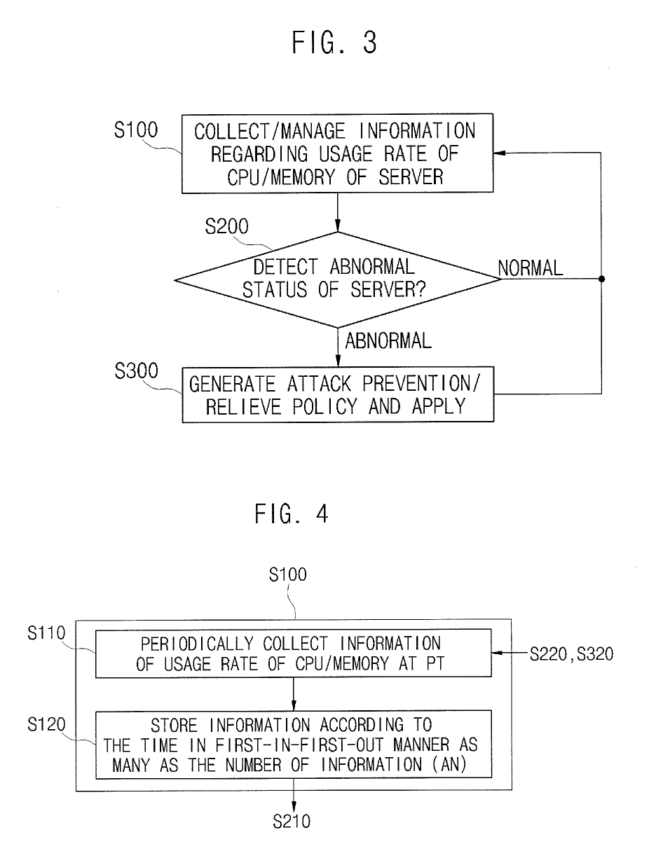

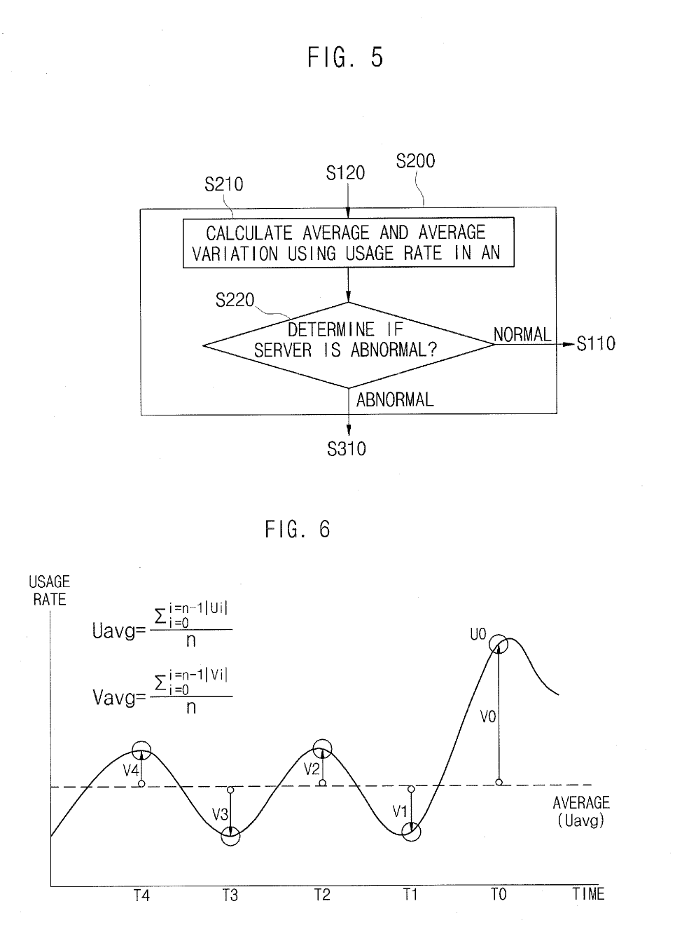

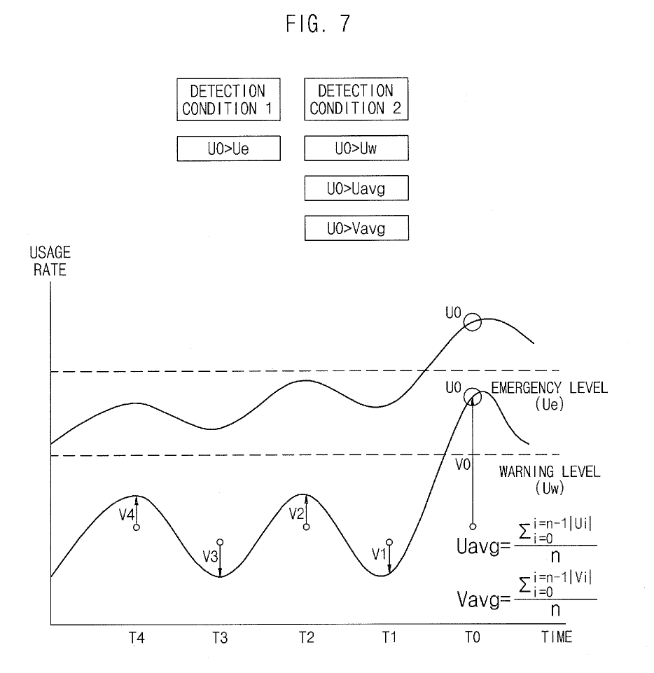

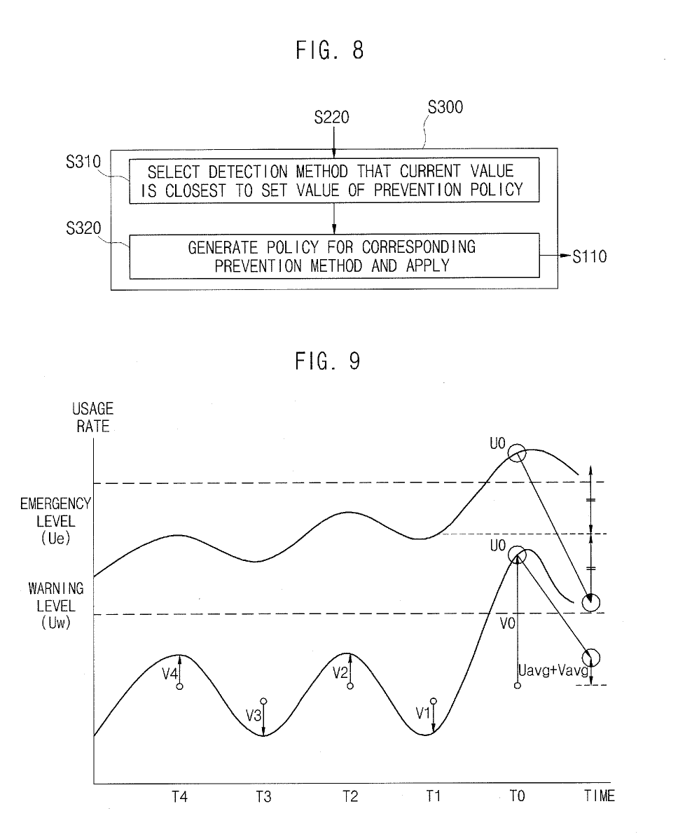

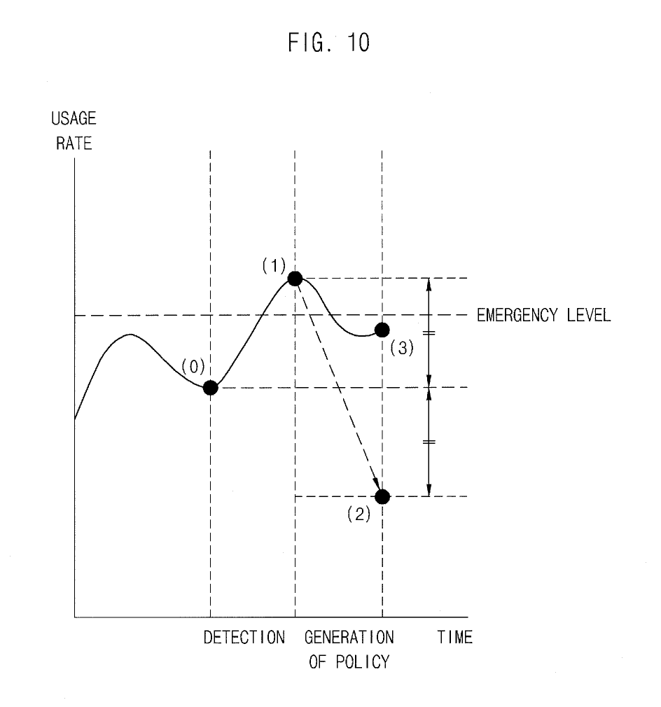

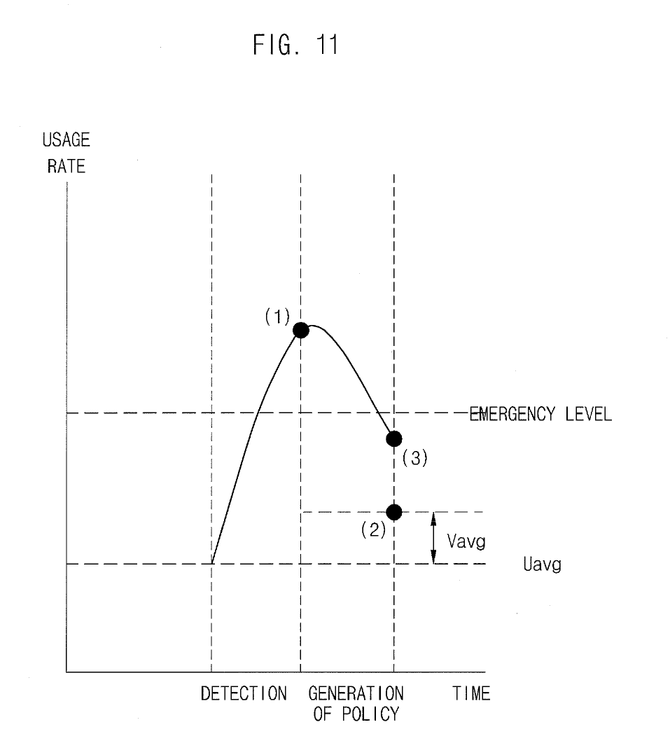

As described above, the concept of an automated control method of DDoS attack prevention policy according to the exemplary embodiment of the present invention has been briefly described with reference to FIGS. 1 and 2. Hereinafter, with reference to FIGS. 3 to 11, an automated control method of DDoS attack prevention policy according to an exemplary embodiment of the invention will be described in detail. FIG. 3 is a flow chart illustrating an automated control method of a DDoS attack prevention policy according to an exemplary embodiment of the present invention. FIG. 4 is a flow chart specifically illustrating step S100. FIG. 5 is a flow chart specifically illustrating step S200. FIG. 6 is a diagram illustrating step S210. FIG. 7 is a diagram illustrating step S220. FIG. 8 is a flow chart specifically illustrating step S300. FIG. 9 is a diagram illustrating step S320. FIG. 10 is a diagram illustrating an operation at an emergency level at step S320. FIG. 11 is a diagram illustrating an operation at a warning level at step S320.

As shown in FIG. 3, the current usage rate (%) of the CPU and the memory of the server is periodically (for example, every second) collected and managed (S100).

The collected usage rate is analyzed to determine if the current server is in an abnormal status (S200). If it is determined that the server is in an abnormal status, the attack prevention policy is generated and applied (S300). For example, in order to recover the current status of the server to the normal status using the information generated in step S100 or S200, a policy of blocking the attack to relieve the usage rate of the CPU and the memory is generated and applied.

If it is determined that the server is not in abnormal status, step S100 continuously proceeds.

Hereinafter, with reference to FIG. 4, step S100 will be more specifically described. The current usage rate of the CPU and the memory of the server is collected at an interval of a periodic time Pt (S110).

On the basis of the number (An) of information collected for every usage rate of the CPU and the memory, the status of the server is analyzed (S120). For example, 60 pieces (An) of information for the usage rate of the CPU and the memory are collected at every second (Pt), and the server status is analyzed based on 60 pieces of collected information.

The information is managed corresponding to the number of information collected for the CPU and the memory in step S110 in a first-in-first-out manner. For example, from 61st information, the status values of the server that are previously input are sequentially deleted and then the current information is stored.

Hereinafter, with reference to FIG. 5, step S200 will be more specifically described. The information regarding the usage rate of the CPU and the memory managed by the first-in-first-out manner in step S120 is used to calculate an average value and an average variation (S210). For example, as shown in FIG. 6, the average value Uave refers to the average of An pieces of previous usage rate information that are collected at every periodical time Pt with respect to the current time T0, and the average variation Vave refers to the average of (An−1) differences between the average value at every periodical time Pt with respect to the current time T0 and the usage rate at that time.

Comparing the current usage rate with the average value and the average variation calculated in step S210, it is determined if the server is in an abnormal status (S220). For example, the abnormal status is classified into an emergency level and a warning level. The normal status is classified into a normal level. As shown in FIG. 7, if the current usage rate U0 is higher than the usage rate Ue at an emergency level in the detection condition 1, it is determined that the status of the current server is abnormal and the server is set to the emergency level.

In the detection condition 2, if the usage rate U0 is higher than the usage rate Uw at a warning level and the average usage rate Uavg and the variation V0 of the current usage rate is higher than the average variation Vavg, it is determined that the current status of the server is abnormal and the level is set to a warning level.

However, even though the previous status is an emergency level or a warning level, if the current status is a normal level, the set value that will be changed in step S320, which will be described later, is set back to a value before changing and step S110 proceeds again.

Hereinafter, with reference to FIG. 8, step S300 will be more specifically described. If it is determined the current server is abnormal in step S220, a preventing policy for changing the set value is selected so that the server can be in normal status (S310). For example, it is compared for every DDoS attack prevention policy how close is the count value of input packet to the set value to block over input of packet to select a prevention policy that has the smallest difference between the count value and the set value.

The set value of the determined (selected) prevention policy is controlled according to the emergency level of the abnormal status of the server and then applied (S320). For example, as shown in FIG. 9, whenever an emergency situation is detected at a current time T0, the current prevention policy is generated so as to decrease the U0 value. At the emergency level, as shown in FIG. 10, if the current usage rate corresponds to (1), the set value of the prevention policy is adjusted so that the current usage rate decreases to (2) and the usage rate corresponds to (3).

If the current set value is R0, the new set value is Rn, the usage rate of (1) is U1, the usage rate of (0) is U0, and the ratio of usage rate is Ur, the following Equation can be obtained.

$$Rn = \frac{Ro \times [ U0 - 2 \times ( U 1 - U 0 ) \times Ur ]}{U 1} \qquad [ Equation 1 ]$$

At the warning level, as shown in FIG. 11, if the current usage rate corresponds to (1), the set value of the prevention policy is adjusted so that the current usage rate decreases to (2), and the usage rate corresponds to (3).

If the current set value is R0, the new set value is Rn, the usage rate of (1) is U1, the average variation is Vavg, the average usage rate is Uavg, and the ratio of the usage rate is Ur, the following Equation can be obtained.

$$Rn = \frac{Ro \times ( Uavg + Ur \times Vavg )}{U 1} \qquad [ Equation 2 ]$$

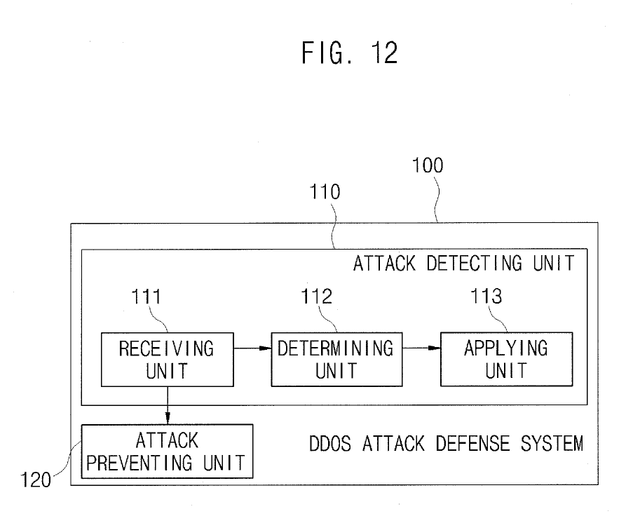

For now, with reference to FIGS. 3 to 11, the automated control method of DDoS attack prevention policy according to the exemplary embodiment of the present invention has been specifically described. Hereinafter, with reference to FIG. 12, an automated control apparatus of a DDoS attack prevention policy according to another exemplary embodiment of the present invention will be described. FIG. 12 is a block diagram illustrating an automated control apparatus of a DDoS attack prevention policy according to an exemplary embodiment of the present invention.

As shown in FIG. 12, the automated control apparatus of a DDoS attack prevention policy according to the exemplary embodiment of the present invention includes a collecting unit 111, a determining unit 112, and an applying unit 113.

The collecting unit 111 collects information regarding the usage rate of the CPU and the memory of a service server. The collecting unit 111 controls the collected information in a first-in-first-out manner.

The determining unit 112 analyzes the collected information to determine whether the service server is abnormal. For example, the service server can be normal or abnormal and the abnormal status is classified into an emergency level and a warning level. If the current usage rate of the CPU and the memory is higher than the usage rate at the emergency level, the determining unit 112 determines that the service server is abnormal and sets the status of the service server to the emergency level. If the current usage rate is higher than the usage rate at the warning level and the average usage rate, and the variation of the current usage rate is higher than the average variation, the determining unit 112 determines that the service server is abnormal and sets the status of the service server to the warning level.

If the determining unit 112 determines that the service server is abnormal, the applying unit 113 generates the policy for preventing the DDoS (Distributed Denial of Service) attack and applies it. For example, the applying unit 113 compares how close is the count value of input packet to the set value to block over input of packet to select a prevention policy that has the smallest difference between the two value for every DDoS attack prevention policy. The set value of the selected prevention policy is controlled to prevent the DDoS attack and applied according to the status of the service server.

According to the exemplary embodiment, the present invention is configured to separate the collecting unit for collecting the information regarding the usage rate of the CPU and the memory from the determining unit for determining the status of the service server based on the collected information. However, the present invention is not limited thereto, but the collecting unit can be included in the determining unit.

As described above, according to the exemplary embodiments of the present invention, by analyzing the actual loads (an usage rate of a CPU and a memory) of the server, any new threat that avoids previously known detection methods is now detected. Specifically, the DDoS attack prevention policy is changed according to the actual loads of the server so that the service failure directly connected to the loads of server is precisely and automatically controlled.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An automated control method of DDoS attack prevention policy of a DDoS attack defense system, the method comprising:
determining a status of a server by monitoring a usage rate of a CPU and a memory of the server that provides services; and
controlling the DDoS attack prevention policy according to the determined status of the server.

2. The method of claim 1, wherein the determining includes:
analyzing an average difference between a variation of a current usage rate and a variation of a past usage rate based on an average difference between the monitored usage rate and the past usage rate of the CPU and the memory of the server that are monitored; and
determining that the server is normal or abnormal based on a result of the analyzing.

3. The method of claim 2, wherein the analyzing includes:
when the current usage rate of the server exceeds a predetermined reference usage rate, analyzing if the current usage rate is higher than the past usage rate by a predetermined usage rate and the variation of the current usage rate is higher than the variation of the past usage rate by a predetermined variation.

4. The method of claim 2, wherein the determining includes:
according to the result of the analyzing, if the current usage rate is higher than the past usage rate by a predetermined usage rate or more and the variation of the current usage rate is higher than the variation of the past usage rate by a predetermined variation or more, determining that the server is abnormal.

5. The method of claim 1, wherein the controlling the DDoS attack prevention policy includes:
controlling a set value of the prevention policy of the DDoS attack defense system based on the difference between the average past usage rate and the current usage rate of the CPU and the memory of the server and the difference between the average variation of the average past usage rate and the variation of the current usage rate.

6. The method of claim 5, wherein the controlling a set value of the prevention policy includes:
setting the set value to enforce the prevention policy as the difference between the current usage rate and the average past usage rate becomes larger, or the difference between the variation of the current usage rate and the average variation of the average past usage rate becomes larger.

7. An automated control method of DDoS attack prevention policy, the method comprising:
collecting information regarding a usage rate of a CPU and a memory of a service server;
determining if the server is abnormal by analyzing the collected information; and
if it is determined that the server is abnormal, generating a DDoS attack prevention policy, and applying the generated policy.

8. The method of claim 7, wherein the collecting of the information includes controlling the collected information in a first-in-first-out manner.

9. The method of claim 7, wherein the determining includes:
calculating the average of the usage rate of the CPU and the memory and the average variation thereof using the collected information; and
comparing the calculated average and the average variation with predetermined reference values and determining if the server is in an abnormal status according to the result of the comparing.

10. The method of claim 9, wherein the abnormal status is classified into an emergency status and a warning status, and
the determining includes:
determining that the server is abnormal if the current usage rate of the CPU and the memory is higher than the usage rate at the emergency status and setting the server to the emergency status, and
determining that the server is abnormal if the current usage rate is higher than the usage rate at the warning status and the average usage rate and the variation of the current usage rate is higher than the average variation, and setting the server to the warning status.

11. The method of claim 7, wherein the generating and applying the DDos attack prevention policy includes:
comparing how close is the count value of input packet for every DDoS attack prevention policy to the set value to block over input of packet to select a DDoS attack prevention policy that has the smallest difference between the count value and the set value; and
controlling the set value of the selected prevention policy to prevent the DDoS attack according to the status of the server, and applying the controlled set value.

12. An automated control apparatus of DDoS attack prevention policy included in a DDoS attack defense system, the apparatus comprising:
a determining unit configured to determine a status of a server by monitoring a usage rate of a CPU and a memory of the server that provides services; and
an applying unit configured to control and applying the DDoS attack prevention policy according to the determined status of the server.

13. The apparatus of claim 12, wherein the determining unit analyzes an average difference between a variation of a current usage rate and a variation of a past usage rate based on an average difference between the current usage rate and the past usage rate of the CPU and the memory the server; and determines that the server is normal or abnormal based on the analyzed result.

14. The apparatus of claim 13, wherein if the current usage rate is higher than the past usage rate by the predetermined usage rate or more and the variation of the current usage rate is higher than the variation of the past usage rate by a predetermined variation or more according to the analyzed result, the determining unit determines that the server is abnormal.

15. The apparatus of claim 12, wherein the applying unit controls a set value of the prevention policy of the DDoS attack defense system based on the difference between the average past usage rate and the current usage rate of the CPU and the memory of the server and the difference between the average variation of the average past usage rate and the variation of the current usage rate.

16. The apparatus of claim 15, wherein the applying unit sets the set value to enforce the prevention policy as the difference between the current usage rate and the average value becomes larger, or the difference between the variation of the current usage rate and the average variation of the average past usage rate becomes larger.

17. An automated control apparatus of DDoS attack prevention policy, the apparatus comprising:
a collecting unit configured to collect information regarding a usage rate of a CPU and a memory of a service server;
a determining unit configured to determine if the server is in abnormal status by analyzing the collected information; and
an applying unit configured to generate and applying an DDoS attack prevention policy if it is determined that the server is in abnormal status.

18. The apparatus of claim 17, wherein the collecting unit controls the collected information in a first-in-first-out manner.

19. The apparatus of claim 17, wherein the abnormal status is classified into an emergency status and a warning status, and:
the determining unit determines that the server is abnormal if a current usage rate of the CPU and the memory is higher than a usage rate at the emergency status and setting the server to the emergency status, and determines that the server is abnormal if the current usage rate is higher than a usage rate at the warning status and an average usage rate and a variation of the current usage rate is higher than an average variation, and setting the server to the warning status.

20. The apparatus of claim 17, wherein the applying unit compares how close is the count value of input packet for every DDoS attack prevention policy to the set value to block over input of packet to select a DDoS attack prevention policy that has the smallest difference between the count value and the set value; and controls the set value of the selected DDoS attack prevention policy according to the status of the server, and applies the controlled set value.
